(19) United States
(12) Patent Application Publication
(10) Pub. No.: US 2020/0160764 A1
(43) Pub. Date: May 21, 2020

(54) Advertising Light Box Frame

(71) Applicant: GUANGZHOU BRANDSTAND DISPLAY SYSTEMS CO. LTD., Guangzhou City (CN)

(72) Inventor: Ralph CANAPHANY, Fairfield East (AU)

(73) Assignee: Guangzhou BrandStand Display Systems Co. Ltd., Guangzhou City (CN)

(21) Appl. No.: 15/580,166

(22) PCT Filed: Dec. 5, 2017
(86) PCT No.: PCT/IB2017/001621

§ 371 Date: Dec. 6, 2017

(30) Foreign Application Priority Data
Jun. 13, 2017 (CN) 201720692835.7

(51) Int. Cl. G09F 13/04

(52) U.S. Cl. CPC G09F 13/0413; G09F 13/22

(57) ABSTRACT

A modular advertising light box frame having a plurality of connectable and detachable vertical elongated frame spans and a plurality of connectable and detachable horizontal elongated cross spans connected by a plurality of angled connectors forming an optimally thin framed light box in which at least one light source is disposed for providing backlighting for an advertisement.

This application claims priority to pending Chinese patent application no. 201720692835.7 filed Jun. 13, 2017 and to PCT Application No. PCT/US17/64659 filed Dec. 5, 2017 is incorporated herein by reference in its entirety.

### BACKGROUND OF THE INVENTION

### Technical Field

The embodiments described and disclosed herein relate to an apparatus and system for portable and modular light box displays used in exposition or marketing settings such as trade shows. The presently described light box includes a modular frame and internal reinforced components that allow for space saving and high portability, which is valuable in settings such as trade shows in which rapid set up and removal of displays is required. The light box described herein includes electronic components that allow illumination of messages or signs on the exterior of the light box frame while maintaining a streamlined configuration.

### Description of Related Art

The advertising light box describe overcomes the shortcomings of prior light boxes by containing electronics and frame providing an illuminated and stable signage at trade show expositions. The lightweight and thin structure of the light box of the present invention serve as walls or partitions for trade show booths that are portable, lightweight, and quickly erectable and removable. The embodiments described herein include a thin walled design allow fabric having advertisement material thereon to be placed within a small distance from light sources of the box. This results in a smaller footprint of each light box, resulting in less high priced square footage wasted on the light box itself.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a front view of a light frame box according to an embodiment of the present disclosure.

FIG. 2 is a perspective view of a light frame box according to an embodiment of the present disclosure.

FIG. 3 is a perspective view of components of alight frame box according to an embodiment of the present disclosure.

FIG. 4 is a front view of a multi-section light frame box according to an embodiment of the present disclosure.

### DETAILED DESCRIPTION OF THE EMBODIMENTS

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

The embodiments of the presently described advertising Light box comprises an ultra-thin box frame preferably comprising aluminum tubing and parallel rows of light emitting diode (LED) lamps. The frame in one embodiment can be constructed of shrink mouth tubing arranged in vertical and horizontal spans forming a rectangular frame or a frame of any configuration according to user requirements.

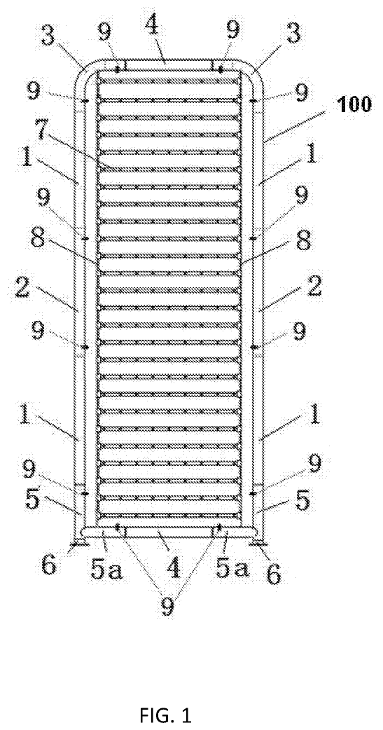

FIG. 1 depicts a front view of an embodiment of the presently described light box assembly. In FIG. 1, light box frame 100 comprises two central tubing spans 2 situated on opposing sides of light box frame 100. Central tubing span 2 is in one embodiment a cylindrical tube of two inches in diameter, with the other light box frame components that form the perimeter of light box frame 100 of the same tubular diameter. In other embodiments, the width or diameter of central tubing span 2 is within a range of one and one-half inches and four inches. The same width or diameter of the various tubing components described herein would be uniform. That is, the width of light box frame 100 at its widest is substantially equal to the largest diameter or width of any span of tubing or otherwise configured framing span. This provides a perimeter frame of light box frame 100 uniform size with a thickness of no more than the diameter of the tubular components of the frame. In one embodiment, light box frame 100, therefore, is two inches thick or in depth. Above and below each of central tubing spans 2 are extension tubing spans 1. Extension tubing spans 1 serve to control the height of light box frame 100 as the number of extension tubing spans 1 connected in series to each individual central tubing span 2 dictates the height of light box frame 100.

Once the number of extension tubing spans 1 necessary to achieve the desired height of light box frame 100 are situated, a corner joining tube 3 is connected to an upper end of the last upper extension tubing span 1 connected on the left and right side of light box frame 100.

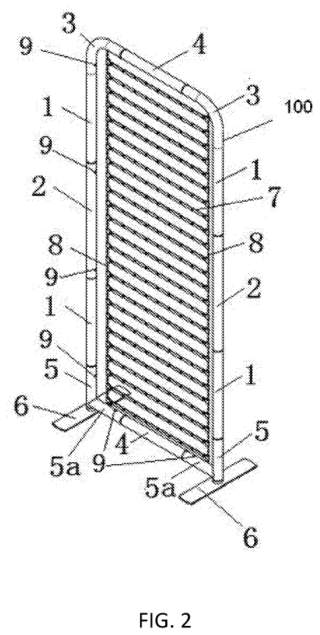

Connected to the lower end of the last lower extension tubing span 1 connected on the left and right side of light box frame 100 is elbow tube 5. Elbow tube 5 is in one embodiment a ninety degree connector for connecting the left and right sides of light box frame 100 to the upper and lower horizontal spans of light box frame 100. Each elbow tube 5 includes a foot 6 that provides a stable base for light box frame 100 to stand despite the thin configuration. As seen in FIG. 2, each foot 6 is of sufficient length in relation to the height of light box frame 100 to provide adequate stability.

Between corner joining tubes 3 is cross tube 4. Similarly, cross tube 4 is situated between elbow tubes 5 at the lower end of light box frame 100. One or more cross tubes 4 may be connected to adjust the width of light box frame 100. Elbow tube 5 includes horizontal elbow tube section 5a. Horizontal elbow tube 5a in one embodiment can include connecting clips 9. Connecting clips 9 can also be situated on one or more of the ends of corner tube 3. FIG. 2 provides a perspective view of light box frame 100.

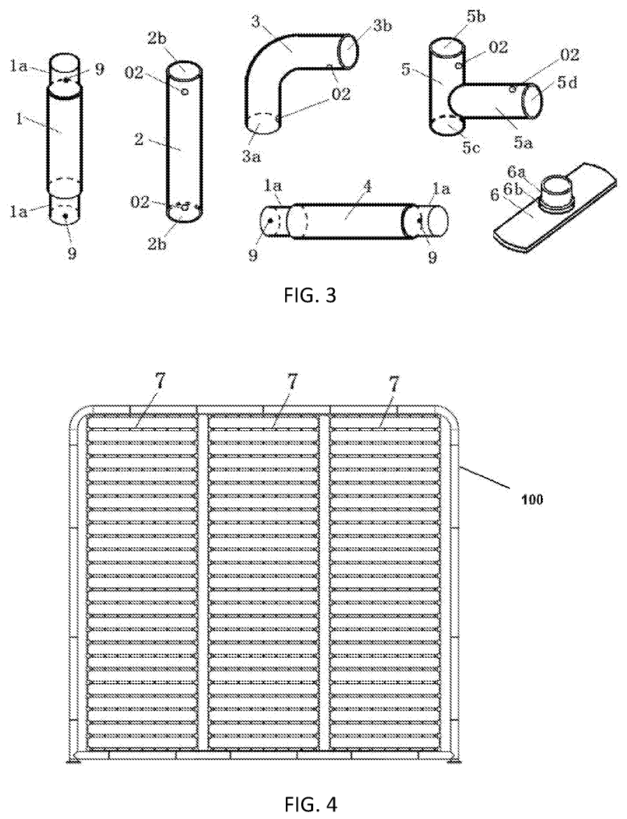

FIG. 3 depicts the various components of light box frame 100. In FIG. 3, extension tubing span 1 includes opposite male throat ends 1a that are sized slightly larger in diameter than female port ends 2b of central tubing span 2 that snugly receive an end of extension tubing span 1. Multiple extension tubing spans 1 can be connected to each other with an additional central tubing span 1 or with a shorter connector (not shown) having two female port ends to receive the male throat ends of extension tubing span 1.

Continuing with the components of FIG. 3, cross tube 4 is shown having opposite male throat ends 1a similar in size of male throat ends 1a of extension tubing span 1. Cross tube 4 also includes pin or grommet 9 that facilitates secure connection of cross tube 4 on an upper side of light box frame 100 with corner joining tube 3. As shown, corner joining tube 3 includes female port ends 3a and 3b for receiving cross tube 4 male throat ends 1a. Corner joining tube 3 also includes apertures 02 near each female port end 3a and 3b to receive pin or grommet 9 to securely connect corner joining tube 3 to cross tube 4.

Also in FIG. 3, elbow tube 5 that the includes vertically arranged female port end 5b for connection to male end 1a of extension tubing span 1 and a horizontally arranged female end 5d on horizontal arm 5a for connection of cross tube 4 serving as the lower end of light box frame 100. Elbow tube 5 also includes a downward facing female port end 5c for connecting foot 6, which includes a male throat end 6a situated substantially in the center of connecting foot 6 and sized to be snugly received by female port end 5c of elbow tube 5 to provide a secure and sturdy base allowing light box frame 100 to stand upright.

Note that all of the male throat ends and their female port end counterparts described herein are sized of substantially similar diameters in order to provide a secure, interlocking fit between connections. Although the embodiment provided describes the frame components as cylindrical tubes, the shapes of the frame components may vary. The various connectors and spans described can be square, rectangular, triangular or have an irregularly shaped profile, depending on the particular use. In addition, the perimeter shape of the described light frame box can be of any shape or form. In one embodiment, the frame pieces are made of aluminum pipe, but other suitable materials can be used to provide a sturdy yet lightweight and highly portable light box frame.

FIG. 4 depicts an embodiment of a light box frame as described herein having three frame sections. Within each frame section is an arrangement of a plurality of horizontally parallel LED lights, to provide back illumination of an advertising message placed over the light box frame.

While the disclosed embodiments have been described with reference to one or more particular implementations, these implementations are not intended to limit or restrict the scope or applicability of the invention. Those having ordinary skill in the art will recognize that many modifications and alterations to the disclosed embodiments are available. Therefore, each of the foregoing embodiments and obvious variants thereof is contemplated as falling within the spirit and scope of the disclosed inventions.

While the invention has been particularly shown and described with reference to a preferred embodiment, it will be understood by those skilled in the art that various changes in form and detail can be made therein without departing from the spirit and scope of the invention.

### ADDITIONAL DESCRIPTION

The following clauses are offered as further description of the disclosed invention.

Clause 1. An advertising light box frame apparatus, comprising: a plurality of connectable and detachable frame spans, comprising
at least one horizontal cross span;
at least one vertical span;
   a plurality of detachable angled connectors, comprising at least one port end for receiving an end of the at least one vertical span; and at least one light source disposed within a frame comprised of the plurality of connectable and detachable frame spans and the plurality of detachable angled connectors,
   wherein a depth of the at least one light source is no more than the width of the at least one vertical span.
   Clause 2. The advertising light box frame apparatus of any proceeding or preceding clause, wherein the width of the at least one vertical span is approximately between one and one-half and four inches.
   Clause 3. The advertising light box frame apparatus of any proceeding or preceding clause, wherein the width of the at least one vertical span is approximately two inches.
   Clause 4. The advertising light box frame apparatus of any proceeding or preceding clause, wherein the width of the at least one vertical span is approximately three inches.
   Clause 5. The advertising light box frame apparatus of any proceeding or preceding clause, wherein an aperture is disposed on at least one end of the at least one horizontal cross span.
   Clause 6. The advertising light box frame apparatus of any proceeding or preceding clause, wherein an aperture is disposed on at least one end of the at least one vertical span.
   Clause 7. The advertising light box frame apparatus of any proceeding or preceding clause, wherein a post is disposed on at least one end of the at least one vertical span corresponding to the aperture disposed on the at least one end of the at least one horizontal cross span.
   Clause 8. The advertising light box frame apparatus of any proceeding or preceding clause, wherein a post is disposed on at least one end of the at least one horizontal cross span corresponding to the aperture disposed on the at least one end of the at least one vertical span.
   Clause 9. The advertising light box frame apparatus of any proceeding or preceding clause, wherein at least one of plurality of detachable angled connectors comprises an elongated foot.
   Clause 10. The advertising light box frame apparatus of any proceeding or preceding clause, wherein the plurality of horizontal cross spans is manufactured of aluminum.
   Clause 11. The advertising light box frame apparatus of any proceeding or preceding clause, wherein the post is a grommet.
   Clause 12. The advertising light box frame apparatus of any proceeding or preceding clause, wherein the post is a grommet.
   Clause 13. The advertising light box frame apparatus of any proceeding or preceding clause, wherein the post is a clip.
   Clause 14. The advertising light box frame apparatus of any preceding clause, wherein the post is a clip.

What is claimed is:

1. An advertising light box frame apparatus, comprising:
a plurality of connectable and detachable frame spans, comprising
at least one horizontal cross span;
at least one vertical span;
a plurality of detachable angled connectors, comprising at least one port end for receiving an end of the at least one vertical span; and at least one light source disposed within a frame comprised of the plurality of connectable and detachable frame spans and the plurality of detachable angled connectors,
wherein a depth of the at least one light source is no more than the width of the at least one vertical span.

2. The advertising light box frame apparatus of claim 1, wherein the width of the at least one vertical span is approximately between one and one-half and four inches.

3. The advertising light box frame apparatus of claim 2, wherein the width of the at least one vertical span is approximately two inches.

4. The advertising light box frame apparatus of claim 2, wherein the width of the at least one vertical span is approximately three inches.

5. The advertising light box frame apparatus of claim 1, wherein an aperture is disposed on at least one end of the at least one horizontal cross span.

6. The advertising light box frame apparatus of claim 1, wherein an aperture is disposed on at least one end of the at least one vertical span.

7. The advertising light box frame apparatus of claim 5, wherein a post is disposed on at least one end of the at least one vertical span corresponding to the aperture disposed on the at least one end of the at least one horizontal cross span.

8. The advertising light box frame apparatus of claim 6, wherein a post is disposed on at least one end of the at least one horizontal cross span corresponding to the aperture disposed on the at least one end of the at least one vertical span.

9. The advertising light box frame apparatus of claim 1, wherein at least one of plurality of detachable angled connectors comprises an elongated foot.

10. The advertising light box frame apparatus of claim 1, wherein the plurality of horizontal cross spans is manufactured of aluminum.

11. The advertising light box frame apparatus of claim 7, wherein the post is a grommet.

12. The advertising light box frame apparatus of claim 8, wherein the post is a grommet.

13. The advertising light box frame apparatus of claim 7, wherein the post is a clip.

14. The advertising light box frame apparatus of claim 8, wherein the post is a clip.
